(19) United States
(12) Patent Application Publication
(10) Pub. No.: US 2025/0110262 A1
(43) Pub. Date: Apr. 3, 2025

(54) OPTICAL MEMBER AND LENS UNIT

(71) Applicants: NIDEC CORPORATION, Kyoto (JP); NIDEC INSTRUMENTS CORPORATION, Nagano (JP)

(72) Inventors: Takeru SUGIMOTO, Kyoto (JP); Takanori KAMOTO, Kyoto (JP); Sayuri NAKAGAWA, Kyoto (JP); Jennifer Torres DAMASCO TY, Kyoto (JP); Masataka KAWAKAMI, Nagano (JP); Yui MIZUSHIMA, Nagano (JP); Akinori YAMAMOTO, Nagano (JP)

(21) Appl. No.: 18/857,815

(22) PCT Filed: Apr. 26, 2023
(86) PCT No.: PCT/JP2023/016441

§ 371 Date: Oct. 18, 2024

(30) Foreign Application Priority Data
Apr. 27, 2022 (JP) 2022-073549
Jan. 31, 2023 (JP) 2023-012889

(51) Int. Cl. G02B 1/115; G02B 1/14; G02B 7/02

(52) U.S. Cl. CPC G02B 1/115; G02B 1/14; G02B 7/021

(57) ABSTRACT

An optical member includes a light-transmissive member, a hard coat layer covering the light-transmissive member, and an antireflection layer covering the hard coat layer. The antireflection layer is configured such that the high refractive index films and the low refractive index films are alternately stacked. The high refractive index film contains Si₃N₄. The low refractive index film contains SiO₂. The total number of films of the high refractive index films and the low refractive index films is an even number. For each of the high refractive index film and the low refractive index film in the antireflection layer, of two adjacent films, a ratio of thickness of a thick film to thickness of a thin film is six times or less. An average reflectance of the antireflection layer in a wavelength range of 300 to 400 nm is 40% or more.

### CROSS-REFERENCE TO RELATED APPLICATIONS

This is the U.S. national stage of application No. PCT/JP2023/016441, filed on Apr. 26, 2023, and priority under 35 U.S.C. § 119 (a) and 35 U.S.C. § 365 (b) is claimed from Japanese Patent Application No. 2022-073549, filed on Apr. 27, 2022, and Japanese Patent Application No. 2023-012889, filed on Jan. 31, 2023.

### FIELD OF THE INVENTION

The present invention relates to an optical member and a lens unit.

### BACKGROUND

In order to protect a light-transmissive member that transmits light, it is known to cover the light-transmissive member with a hard coat film harder than the light-transmissive member. In this case, when the light-transmissive member and the hard coat film are exposed to an ultraviolet ray, a crack may occur in the hard coat film, and therefore it has been studied to cover the hard coat film with an antireflection film.

Conventionally, there is an optical member including an antireflection film in which 11 to 15 layers of a low refractive index layer made from a metal oxide having a relatively low refractive index and a high refractive index layer made from a metal oxide having a relatively high refractive index are laminated on a hard coat film covering a resin substrate. The conventional optical member exhibits a high reflectance when ultraviolet light is incident at a relatively small incident angle, and exhibits a low luminous reflectance when ultraviolet light is incident at a relatively large incident angle, so that occurrence of a crack in a hard coat film is prevented.

However, in the conventional optical member, the antireflection film may be peeled off when an ambient environment changes. For example, in a case where the conventional optical member is left outdoors for a long time, the antireflection film may be peeled off due to a temperature change or a climate change.

### SUMMARY

An exemplary optical member of the present invention includes a light-transmissive member, a hard coat layer covering the light-transmissive member, and an antireflection layer covering the hard coat layer. The antireflection layer is configured such that high refractive index films and low refractive index films are alternately stacked. The high refractive index film contains Si₃N₄. The low refractive index film contains SiO₂. The total number of films of the high refractive index films and the low refractive index films is an even number. For each of the high refractive index films and the low refractive index films in the antireflection layer, of two adjacent films, a ratio of thickness of a thick film to thickness of a thin film is six times or less. An average reflectance of the antireflection layer in a wavelength range of 300 to 400 nm is 40% or more.

An exemplary lens unit of the present invention includes a plurality of lenses, and at least one lens of a plurality of the lenses is the optical member described above.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic diagram of an example of an optical member according to the present embodiment;

FIG. 2 is a table showing a film configuration of an antireflection layer in the optical member according to the present embodiment; and

FIG. 3 is a schematic diagram of an example of a lens unit according to the present embodiment.

### DETAILED DESCRIPTION

Hereinafter, an optical member according to an embodiment of the present invention will be described with appropriate reference to the drawings. Note that in the drawings, the same or corresponding parts will be denoted by the same reference signs and will be omitted from description. A magnitude relationship between dimensions, shapes, and constituent elements in the drawings are not necessarily the same as a magnitude relationship between actual dimensions, shapes, and constituent elements. In particular, thicknesses of an antireflection layer, a hard coat layer, and a light-transmissive member in the drawings may be greatly different from actual thicknesses of the antireflection layer, the hard coat layer, and the light-transmissive member. Note that, in the present description, “thickness” of each portion of the optical member indicates a length in an optical axis direction of the optical member.

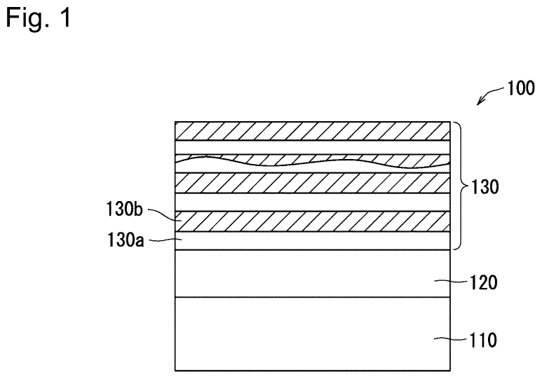

Hereinafter, an optical member 100 according to the present embodiment will be described with reference to FIG. 1. FIG. 1 is a schematic diagram of the optical member 100 according to the present embodiment.

The optical member 100 includes a light-transmissive member 110, a hard coat layer 120, and an antireflection layer 130. The light-transmissive member 110, the hard coat layer 120, and the antireflection layer 130 are laminated in this order. Typically, the light-transmissive member 110, the hard coat layer 120, and the antireflection layer 130 are arranged in close contact in this order.

The light-transmissive member 110 transmits light. The light-transmissive member 110 has light-transmissivity. The light-transmissive member 110 may be transparent or translucent. Typically, the light-transmissive member 110 is made from resin. The light-transmissive member 110 may be formed of a single member. For example, the light-transmissive member 110 contains resin having a cyclic imide structure as a ring structure. Examples of such resin include AZP manufactured by Asahi Kasei Corporation, RM-104, RM-250, and RM-100-Z manufactured by NIPPON SHOKUBAI CO., LTD.

The light-transmissive member 110 has a flat surface. Note that at least one surface of the light-transmissive member 110 may be a convex surface or a concave surface. When the light-transmissive member 110 has a convex surface or a concave surface, the light-transmissive member 110 functions as a lens (specifically, for example, a biconvex lens, a planoconvex lens, a convex meniscus lens, and a concave meniscus lens).

The hard coat layer 120 covers the light-transmissive member 110. The hard coat layer 120 covers the air side of the light-transmissive member 110. The hard coat layer 120 has higher hardness than the light-transmissive member 110. The hard coat layer 120 imparts scratch resistance to the light-transmissive member 110 and improves adhesion between the light-transmissive member 110 and the antireflection layer 130.

The hard coat layer 120 preferably transmits light. For example, the hard coat layer 120 has light-transmissivity. The hard coat layer 120 may be transparent or translucent.

In the present embodiment, the hard coat layer 120 includes a base layer. Typically, the base layer includes an organic material layer or an organosilicon compound layer. Further, in the hard coat layer 120, metal oxide fine particles may be dispersed in the base layer.

The antireflection layer 130 covers the hard coat layer 120. The antireflection layer 130 covers the air side of the hard coat layer 120. The antireflection layer 130 suppresses reflection of light. The antireflection layer 130 prevents at least a part of light about to enter the light-transmissive member 110 from being reflected on a surface. For example, the antireflection layer 130 preferably prevents visible light about to enter the light-transmissive member 110 from being reflected on a surface.

Thickness of the antireflection layer 130 is 100 nm or more and 1000 nm or less. Thickness of the antireflection layer 130 may be 200 nm or more and 900 nm or less, or may be 300 nm or more and 800 nm or less.

The antireflection layer 130 includes high refractive index films 130a and low refractive index films 130b. The antireflection layer 130 is configured such that the high refractive index films 130a and the low refractive index films 130b are alternately stacked. The antireflection layer 130 has a film stacking structure.

A refractive index of the high refractive index film 130a is higher than a refractive index of the low refractive index film 130b. Typically, in a visible range, a refractive index of the high refractive index film 130a is higher than a refractive index of the low refractive index film 130b.

The high refractive index film 130a contains trisilicon tetranitride (Si₃N₄). The low refractive index film 130b contains silicon dioxide (SiO₂). As described above, the high refractive index film 130a contains trisilicon tetranitride (Si₃N₄), and the low refractive index film 130b contains silicon dioxide (SiO₂), so that thermal shock resistance can be improved.

For example, the high refractive index film 130a is 1.9 or more. In one example, the high refractive index film 130a is 1.9 or more and 2.3 or less.

For example, a refractive index of the low refractive index film 130b is 1.5 or more and 1.8 or less. In one example, a refractive index of the low refractive index film 130b is 1.6 or more and 1.75 or less.

Thickness of the high refractive index film 130a and the low refractive index film 130b is 5 nm or more and 200 nm or less. As a result, the high refractive index film 130a and the low refractive index film 130b can be uniformly formed, and a plurality of the high refractive index films 130a and the low refractive index films 130b can be arranged in the antireflection layer 130. Thicknesses of the high refractive index film 130a and the low refractive index film 130b may be 10 nm or more and 180 nm or less, or 20 nm or more and 170 nm or less.

The antireflection layer 130 has a film stacking structure. In the antireflection layer 130, the number of films of the high refractive index films 130a is the same as the number of films of the low refractive index films 130b, and in the antireflection layer 130, the total number of films of the high refractive index films 130a and the low refractive index films 130b is an even number. Typically, trisilicon tetranitride (Si₃N₄) exhibits compressive stress and silicon dioxide (SiO₂) exhibits tensile stress. As described above, the high refractive index film 130a and the low refractive index film 130b exhibit different stress. Since the number of films of the high refractive index films 130a is the same as the number of films of the low refractive index films 130b, stress balance can be maintained in the antireflection layer 130, so that durability can be improved.

The total number of films of the high refractive index films 130a and the low refractive index films 130b is preferably ten or less. The high refractive index film 130a and the low refractive index film 130b may be formed by sputtering. By forming by sputtering, thicknesses of the high refractive index film 130a and the low refractive index film 130b can be more precisely controlled. Since the total number of films of the high refractive index films 130a and the low refractive index films 130b is ten or less, even in a case where the high refractive index film 130a and the low refractive index film 130b are formed by sputtering at high temperature, formation time of the antireflection layer 130 can be shortened, and a load on the light-transmissive member 110 can be reduced.

Note that, when the antireflection layer 130 is formed, even in a case where a film containing Si₃N₄ is continuously formed via interruption or the like, one film of the high refractive index film 130a is formed. The same applies to the low refractive index film 130b.

As described above, the total number of films of the high refractive index films 130a and the low refractive index films 130b is preferably ten or less. By the above, stress in the antireflection layer 130 can be easily adjusted. For example, the total number of films of the high refractive index films 130a and the low refractive index films 130b may be six or more and eight or less. Thus, the antireflection layer 130 having appropriate hardness can be easily formed.

In the present description, the order of films may be described in the order closer to the hard coat layer 120 among stacked films of the antireflection layer 130. For example, a film closest to the hard coat layer 120 among stacked films of the antireflection layer 130 is referred to as a first film, and a film next closest to the hard coat layer 120 after the first film among the stacked films of the antireflection layer 130 is referred to as a second film.

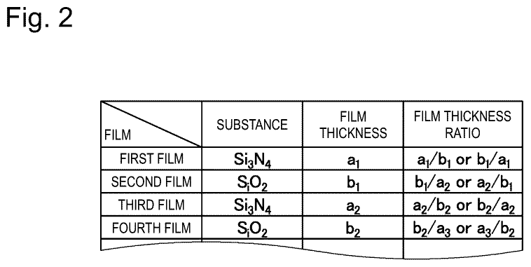

In the antireflection layer 130, the high refractive index films 130a and the low refractive index films 130b are alternately arranged. In the antireflection layer 130, a difference in film thickness between the high refractive index film 130a and the low refractive index film 130b adjacent to each other is preferably relatively small. For example, as can be understood from FIG. 2, film thickness of a thicker one of the high refractive index film 130a and the low refractive index film 130b adjacent to each other in the antireflection layer 130 is preferably six times or less film thickness of the other, which is thinner. In the present description, a ratio of film thickness of a thick film to film thickness of a thin film of two adjacent ones of the high refractive index films 130a and low refractive index films 130b may be referred to as a “film thickness ratio”. When the film thickness ratio is six times or less, hardness of the antireflection layer 130 can be improved.

In one example, in the antireflection layer 130, a second film is sandwiched between a first film and a third film. In this case, in film thicknesses of the first film and the second film, film thickness of a thick film is preferably six times or less film thickness of a thin film. For example, in a case where film thickness of the first film is larger than film thickness of the second film, the film thickness of the first film is preferably six times or less the film thickness of the second film. Alternatively, in a case where film thickness of the second film is larger than film thickness of the first film, the film thickness of the second film is preferably six times or less the film thickness of the first film.

Similarly, in film thicknesses of a second film and a third film, film thickness of a thick film is preferably six times or less film thickness of a thin film. For example, in a case where film thickness of the second film is larger than film thickness of the third film, the film thickness of the second film is preferably six times or less the film thickness of the third film. Alternatively, in a case where film thickness of the third film is larger than film thickness of the second film, the film thickness of the third film is preferably six times or less the film thickness of the second film.

As described above, in the antireflection layer 130, the total number of films of the high refractive index films 130a and the low refractive index films 130b is an even number. For this reason, a first film of the antireflection layer 130 closest to the hard coat layer 120 is different from a film (outermost film) farthest from the hard coat layer 120. For example, in a case where the first film is the high refractive index film 130a, the outermost film is the low refractive index film 130b. On the other hand, in a case where the first film is the low refractive index film 130b, the outermost film is the high refractive index film 130a.

In the antireflection layer 130, by adjusting film thickness of the high refractive index film 130a and film thickness of the low refractive index film 130b, the antireflection layer 130 can have an average reflectance in a wavelength range (300 to 400 nm) corresponding to an ultraviolet range of 40% or more and an average reflectance in a wavelength range (450 to 800 nm) corresponding to a visible range of 2.0% or less. This makes it possible to suppress incidence of ultraviolet light on the hard coat layer 120 and the light-transmissive member 110 via the antireflection layer 130, and to suppress lowering in adhesion between the antireflection layer 130, the hard coat layer 120, and the light-transmissive member 110. Further, visible light can be transmitted through the hard coat layer 120 and the light-transmissive member 110 via the antireflection layer 130.

An outermost film of the antireflection layer 130 is preferably the low refractive index film 130b containing SiO₂. This makes it possible to easily reduce a reflectance in a visible range. In this case, since the total number of films is an even number in the antireflection layer 130, a film adjacent to the hard coat layer 120 in the antireflection layer 130 is the high refractive index film 130a.

Further, according to the optical member 100 of the present embodiment, an average reflectance at a wavelength (for example, 300 to 400 nm) corresponding to an ultraviolet range can be 40% or more, and an average reflectance at a wavelength (for example, 450 to 800 nm) corresponding to a visible range can be 2.0% or less. Therefore, ultraviolet light can be prevented from entering the optical member 100. By the above, deterioration of the optical member 100 due to an ultraviolet ray can be suppressed, so that durability quality of the optical member 100 can be improved. The optical member 100 as described above is suitably used, for example, as a lens for a lens unit of an in-vehicle camera for monitoring around a vehicle.

The optical member 100 of the present embodiment includes the light-transmissive member 110, the hard coat layer 120 covering the light-transmissive member 110, and the antireflection layer 130 covering the hard coat layer 120. The antireflection layer 130 is configured such that the high refractive index films 130a and the low refractive index films 130b are alternately stacked. The high refractive index film 130a contains Si₃N₄, and the low refractive index film 130b contains SiO₂. The total number of films of the high refractive index films 130a and the low refractive index films 130b is an even number. For each of the high refractive index film 130a and the low refractive index film 130b in the antireflection layer 130, of two adjacent films, a ratio of thickness of a thick film to thickness of a thin film is six times or less. An average reflectance of the antireflection layer 130 in a wavelength range of 300 to 400 nm is 40% or more. By the above, durability of the optical member 100 can be improved.

Further, the total number of films of the high refractive index films 130a and the low refractive index films 130b is preferably ten or less. By the above, stress in the antireflection layer 130 can be easily adjusted.

The total number of films of the high refractive index films 130a and the low refractive index films 130b is preferably six or more and eight or less. By the above, hardness of the antireflection layer 130 can be appropriately adjusted.

In the antireflection layer 130, a film located farthest from the hard coat layer 120 is preferably one of the low refractive index films 130b. By the above, a reflectance of the antireflection layer 130 can be easily reduced in a visible range.

Note that the antireflection layer 130 preferably transmits light in a visible range and reflects light in an ultraviolet range. Note that a reflectance of the antireflection layer 130 may be acquired by actual measurement or calculation.

A reflectance of the antireflection layer 130 can be acquired by calculation. For example, propagation of an electromagnetic wave through a thin film stack can be predicted using Essential Mcleod software that models optical coating by using a transfer matrix method. An optical interference matrix is an effective method for calculating a reflectance of a stacked film. Under a situation where an incident angle of light is zero degrees, considering an optical thin film system of N films, nⱼ is a refractive index, kⱼ is an absorption coefficient, dⱼ is thickness of each film, and n₀ is a refractive index of air (n₀=1). A reflectance of a stacked film can be calculated by optical admittance (Y) which is a ratio between a magnetic field (C) and an electric field (B) in all tangential directions. According to a refractive index and thickness of each film, an interference matrix of each film can be determined using a characteristic matrix expressed by Mathematical formula (1) below.

$$[ Mathematical formula 1 ]$$

$$[ \begin{matrix}B \\ C\end{matrix} ] = \{ {\prod }_{r = 1}^{q} [ \begin{matrix}cos {δ}_{r} & ( i sin {δ}_{r} ) / {n}_{r} \\ {in}_{r} ( sin {δ}_{r} ) & cos {δ}_{r}\end{matrix} ] \} [ \begin{matrix}1 \\ {n}_{m}\end{matrix} ] \qquad ( 1 )$$

Here, δᵣ=2πNd cos θ/λ is effective optical thickness of a film at a specific wavelength and nₘ is a refractive index of a substrate. In a case where q is a film adjacent to a substrate, the order is as described below.

$$[ Mathematical formula 2 ]$$

$$[ \begin{matrix}B \\ C\end{matrix} ] = [ {M}_{1} ] [ {M}_{2} ] … [ {M}_{q} ] [ \begin{matrix}1 \\ {n}_{m}\end{matrix} ] \qquad ( 2 )$$

M₁ represents a matrix associated with a first film. The same applies to M₂ and the like. As in a case of a single surface, n₀ does not require that a reflectance be a real number, but that a transmittance have a valid meaning. Using Mathematical formula (1) and Mathematical formula (2), a reflectance (R) can be derived as shown in Mathematical formula (3).

$$[ Mathematical formula 3 ]$$

$$R = ( \frac{{n}_{0} B - C}{{n}_{0} B + C} ) {( \frac{{n}_{0} B - C}{{n}_{0} B + C} )}^{*} \qquad ( 3 )$$

As described above, the antireflection layer 130 preferably transmits light in a visible range and reflects light in an ultraviolet range. The antireflection layer 130 preferably has an average reflectance of 2.0% or less at a wavelength of 450 to 800 nm and an average reflectance of 40% or more at a wavelength of 300 to 400 nm.

The optical member 100 of the present embodiment exhibits relatively high durability. For this reason, the optical member 100 is suitably used for a surveillance camera or an in-vehicle camera. Even in a case where a surveillance camera or an in-vehicle camera is used for a long time in an outdoor environment, the optical member 100 can be continuously used.

Note that, in the optical member 100 illustrated in FIG. 1, the hard coat layer 120 and the antireflection layer 130 are arranged on one surface side of the light-transmissive member 110, but the present embodiment is not limited to this. The hard coat layer 120 and the antireflection layer 130 may be arranged on both sides of the light-transmissive member 110.

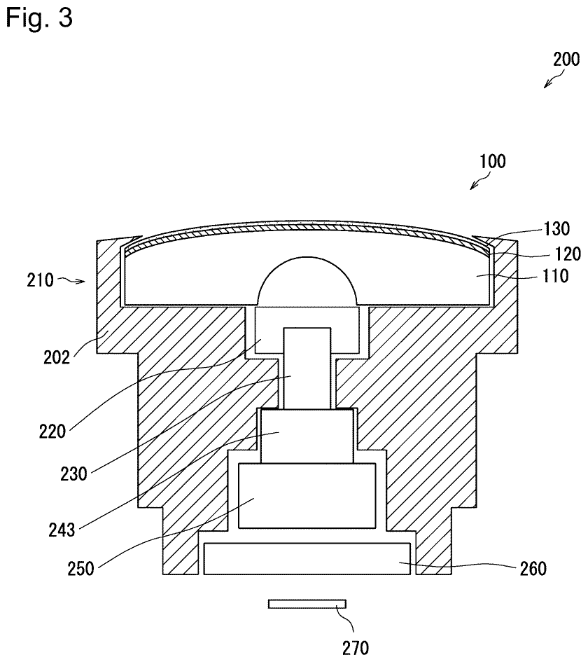

Next, a lens unit 200 according to the present embodiment will be described with reference to FIGS. 1 to 3. FIG. 3 is a schematic diagram of an example of the lens unit 200 according to the present embodiment.

The lens unit 200 includes a plurality of lenses, and at least one lens of a plurality of lenses is the optical member 100.

The lens unit 200 includes a first lens 210, a second lens 220, a third lens 230, a fourth lens 240, and a fifth lens 250. The first lens 210, the second lens 220, the third lens 230, the fourth lens 240, and the fifth lens 250 are arranged in order from the object side toward the image side.

For example, the first lens 210 is the optical member 100 described above. That is, the first lens 210 includes the light-transmissive member 110, the hard coat layer 120, and the antireflection layer 130 described above.

The lens unit 200 further includes a lens barrel 202 and a filter 260. The first lens 210, the second lens 220, the third lens 230, the fourth lens 240, and the fifth lens 250 are installed in the lens barrel 202. At least one of the first lens 210, the second lens 220, the third lens 230, the fourth lens 240, and the fifth lens 250 may be arranged such that at least a part of the lens is exposed from lens barrel 202. For example, the first lens 210 is arranged such that at least a part of the lens is exposed from the lens barrel 202, and the other second lens 220, third lens 230, fourth lens 240, and fifth lens 250 are arranged in the lens barrel 202.

Note that an imaging element 270 may be arranged on the image side with respect to the filter 260 (lens unit 200). For example, as illustrated in FIG. 3, the imaging element 270 is arranged outside the lens unit 200.

The filter 260 is arranged on the image side with respect to the fifth lens 250. A wavelength of light reaching the imaging element 270 can be selected with the filter 260. The imaging element 270 is a photoelectric conversion element that converts emitted light into an electric signal. The imaging element 270 is, for example, a CMOS image sensor, a CCD image sensor, or the like. However, the imaging element 270 is not limited to this. The imaging element 270 captures an image of a subject formed by a plurality of lenses.

The first lens 210 is a negative meniscus lens with a convex surface facing the object side. In the present embodiment, a surface on the object side including a convex surface of the first lens 210 is a spherical surface, and a surface on the image side including a concave surface is an aspherical surface.

The second lens 220, the third lens 230, the fourth lens 240, and the fifth lens 250 may be made from resin (plastic lens) or glass.

The second lens 220, the third lens 230, the fourth lens 240, and the fifth lens 250 may be any of a biconvex lens, a planoconvex lens, a convex meniscus lens, and a concave meniscus lens.

The lens unit 200 is suitably used as an in-vehicle lens for photographing around a vehicle. For example, the lens unit 200 is used as an in-vehicle lens for photographing the rear or side of a vehicle.

Since the first lens 210 includes the light-transmissive member 110, the hard coat layer 120, and the antireflection layer 130 described above, an ultraviolet ray entering the lens barrel 202 can be suitably suppressed. For this reason, even when a plastic lens is used as a lens in the lens barrel 202, deterioration of the plastic lens can be suppressed.

As described above, since the lens unit 200 includes a plurality of lenses and at least one lens of a plurality of lenses is the optical member 100, deterioration of a lens in the lens unit 200 can be suppressed.

Further, the first lens 210 including the light-transmissive member 110, the hard coat layer 120, and the antireflection layer 130 described above is arranged to be exposed from the lens barrel 202, and remaining lenses (the second lens 220, the third lens 230, the fourth lens 240, and the fifth lens 250) are arranged in the lens barrel 202, so that deterioration of lenses other than the first lens 210 having high durability can be suppressed.

### Example

First, the optical member 100 of Example 1 will be described.

The light-transmissive member 110 made from RM-104 manufactured by NIPPON SHOKUBAI CO., LTD. was prepared. The light-transmissive member 110 was a meniscus lens having a convex surface facing the object side, and the light-transmissive member 110 had a lens outer diameter of about 14 mm.

A surface of the light-transmissive member 110 was coated with a hard coat layer 120. The hard coat layer 120 was a photocurable resin material made from urethane or the like. The hard coat layer 120 was formed by applying coating liquid to the light-transmissive member 110 by a spin coating method, then heating and drying a coating film formed of the coating liquid, and then photocuring the coating film with an electromagnetic wave such as an ultraviolet ray or an electron beam.

A surface of the hard coat layer 120 was coated with the antireflection layer 130. In the antireflection layer 130, high refractive index films made from Si₃N₄ and low refractive index films made from SiO₂ were alternately formed by a sputtering method. In the optical member 100 of Example 1, eight films of high refractive index films and low refractive index films were alternately formed.

Table 1 shows the configuration of the antireflection layer 130 in the optical member 100 of Example 1.

TABLE 1

| | | | Film | Film |
|---|---|---|---|---|
| Film configuration of | | | thickness | thickness |
| antireflection layer | | Substance | (nm) | ratio |
| First film | High refractive index film | Si₃N₄ | 23.72 | 2.4 |
| Second film | Low refractive index film | SiO₂ | 56.20 | 1.5 |
| Third film | High refractive index film | Si₃N₄ | 36.36 | 1.7 |
| Fourth film | Low refractive index film | SiO₂ | 60.03 | 1.3 |
| Fifth film | High refractive index film | Si₃N₄ | 44.70 | 1.1 |
| Sixth film | Low refractive index film | SiO₂ | 39.05 | 1.3 |
| Seventh film | High refractive index film | Si₃N₄ | 51.80 | 2.2 |
| Eighth film | Low refractive index film | SiO₂ | 111.78 | — |

In the optical member 100 of Example 1, film thickness of the high refractive index films 130a and the low refractive index films 130b, eight films in total, was set so that an average reflectance in a wavelength range (300 to 400 nm) corresponding to an ultraviolet range is 40% or more and an average reflectance in a wavelength range (450 to 800 nm) corresponding to a visible range is 2.0% or less. Here, the average reflectance was set at an incident angle of five degrees for each of ultraviolet light and visible light.

In the antireflection layer 130 of the optical member 100 of Example 1, an average reflectance in an ultraviolet range was set to 49.6%, and an average reflectance in a visible range was set to 1.0%. In the optical member 100 of Example 1, ultraviolet light can be prevented from entering. This makes it possible to suppress deterioration of the optical member 100 of Example 1 due to an ultraviolet ray, and improve weather resistance.

Next, the optical member 100 of Example 1 was subjected to a thermal shock test of the optical member 100 and a weather resistance test of the antireflection layer 130 under a condition below.

A thermal shock test was performed using a thermal shock testing device. In the thermal shock test, the optical member 100 of Example 1 was left standing in an environment at 85° C. (high temperature) for 30 minutes and then left standing in an environment at −40° C. (low temperature) for 30 minutes, which was defined as one cycle, and repeated 1000 cycles. During and after the thermal shock test, whether or not peeling or cracking occurred in the antireflection layer 130 of the optical member 100 was checked.

A weather resistance test was performed using a high acceleration weather resistance tester 7.5 kW superxenon weather meter. In the weather resistance test, after 18 minutes of irradiation+rainfall at an irradiance of 180 W/m², only irradiation was performed for 102 minutes as one cycle, and 500 cycles were repeated. During and after the weather resistance test, whether the antireflection layer 130 was peeled off was checked.

Table 2 shows a result of a thermal shock test of the optical member 100 of Example 1 and a weather resistance test of the antireflection layer 130. In the present description, after a thermal shock test, one having no peeling or cracking in a visual inspection under a fluorescent lamp is indicated by ∘, and one having peeling or cracking is indicated by x. Further, in the present description, after a weather resistance test, in a visual inspection under a fluorescent lamp, one having no peeling is indicated by “∘”, and one having peeling is indicated by “x”.

TABLE 2

| | |
|---|---|
| Number of films | Eight films |
| Substance High refractive | Si₃N₄ |
| index film | |
| Substance Low refractive | SiO₂ |
| index film | |
| Average reflectance (%) | 49.6 |
| 5° incidence 300-400 nm | |
| Average reflectance (%) | 1.0 |
| 5° incidence 450-800 nm | |
| Thermal shock resistance | ◯ |
| (85° C. ⇔ −40° C. × 1000 h) | |
| Weather resistance | ◯ |
| (weather meter 180 W/m²) | |

As shown in Table 2, in the optical member 100 of Example 1, it was confirmed that peeling did not occur in the antireflection layer 130 even after the thermal shock test and the weather resistance test.

The optical members 100 of Examples 2 to 5 were produced in the same manner as the optical member 100 of Example 1. The optical members 100 of Examples 2 to 5 were also subjected to a thermal shock test and a weather resistance test in the same manner as the optical member 100 of Example 1.

Table 3 shows a configuration of the antireflection layer 130 in the optical members 100 of Examples 1 to 5. Note that, in any of the optical members 100 of Examples 2 to 5, film thickness of the high refractive index film 130a and the low refractive index film 130b of the antireflection layer 130 was set such that an average reflectance in a case where light having a wavelength of 300 to 400 nm was incident at an incident angle of 5° was 40% or more, and an average reflectance in a case where light having a wavelength of 450 to 800 nm was incident at an incident angle of 5° was 2% or less.

TABLE 3

| Film | | | | | | | | | | | |
|---|---|---|---|---|---|---|---|---|---|---|---|
| configuration | | Example 1 | | Example 2 | | Example 3 | | Example 4 | | Example 5 | |
| of | | Film | Film | Film | Film | Film | Film | Film | Film | Film | Film |
| antireflection | | thickness | thickness | thickness | thickness | thickness | thickness | thickness | thickness | thickness | thickness |
| layer | Substance | (nm) | ratio | (nm) | ratio | (nm) | ratio | (nm) | ratio | (nm) | ratio |
| First film | Si₃N₄ | 23.72 | 2.4 | 26.94 | 2.6 | 34.27 | 1.5 | 36.88 | 1.4 | 7.45 | 1.5 |
| Second film | SiO₂ | 56.20 | 1.5 | 68.87 | 2.0 | 52.71 | 1.1 | 50.19 | 1.1 | 5.07 | 5.9 |
| Third film | Si₃N₄ | 36.36 | 1.7 | 34.95 | 1.6 | 48.11 | 1.3 | 47.31 | 1.3 | 29.66 | 1.6 |
| Fourth film | SiO₂ | 60.03 | 1.3 | 57.31 | 1.2 | 61.07 | 1.5 | 61.69 | 1.5 | 46.57 | 1.1 |
| Fifth film | Si₃N₄ | 44.70 | 1.1 | 49.24 | 2.3 | 40.78 | 1.4 | 40.66 | 1.4 | 50.58 | 1.1 |
| Sixth film | SiO₂ | 39.05 | 1.3 | 115.63 | — | 55.34 | 1.2 | 56.07 | 1.2 | 57.85 | 1.3 |
| Seventh film | Si₃N₄ | 51.80 | 2.2 | — | — | 47.79 | 2.4 | 47.08 | 2.5 | 43.92 | 1.2 |
| Eighth film | SiO₂ | 111.78 | — | — | — | 115.66 | — | 116.46 | — | 51.49 | 1.1 |
| Ninth film | Si₃N₄ | — | — | — | — | — | — | — | — | 48.64 | 2.4 |
| Tenth film | SiO₂ | — | — | — | — | — | — | — | — | 116.48 | — |

In the optical member 100 of Example 2, the total number of films of the antireflection layer 130 is six. Also here, a first film is the high refractive index film 130a, and a sixth film which is the outermost film is the low refractive index film 130b. A film thickness ratio is 1.2 or more and 2.6 or less.

In the optical member 100 of Example 3, the total number of films of the antireflection layer 130 is eight. Also here, a first film is the high refractive index film 130a, and an eighth film which is the outermost film is the low refractive index film 130b. A film thickness ratio is 1.1 or more and 2.4 or less.

In the optical member 100 of Example 4, the total number of films of the antireflection layer 130 is eight. Also here, a first film is the high refractive index film 130a, and an eighth film which is the outermost film is the low refractive index film 130b. A film thickness ratio is 1.1 or more and 2.5 or less.

In the optical member 100 of Example 5, the total number of films of the antireflection layer 130 is ten. Also here, a first film is the high refractive index film 130a, and a tenth film which is the outermost film is the low refractive index film 130b. A film thickness ratio is 1.1 or more and 5.9 or less.

Further, optical members of Comparative Examples 1 to 7 were produced in the same manner as the optical member 100 of Example 1. Similarly to the optical member 100 of Example 1, the optical members of Comparative Examples 1 to 7 were also subjected to a thermal shock test and a weather resistance test.

Table 4 shows a configuration of an antireflection layer in the optical members of Comparative Examples 1 to 7. Note that, in any of the optical members of Comparative Examples 1 to 6, film thickness of a high refractive index film and a low refractive index film of the antireflection layer was set such that an average reflectance in a case where light having a wavelength of 300 to 400 nm was incident at an incident angle of 5° was 40% or more, and an average reflectance in a case where light having a wavelength of 450 to 800 nm was incident at an incident angle of 5° was 2% or less. However, in the optical member of Comparative Example 7, film thickness of a high refractive index film and a low refractive index film of the antireflection layer was set such that an average reflectance in a case where light having a wavelength of 450 to 800 nm was incident at an incident angle of 5° was 2% or less, while an average reflectance in a case where light having a wavelength of 300 to 400 nm was incident at an incident angle of 5° was less than 40%.

TABLE 4

| Film | | Comparative Example 1 | | Comparative Example 2 | | Comparative Example 3 | | Comparative Example 4 | |
|---|---|---|---|---|---|---|---|---|---|
| configuration | | Film | Film | Film | Film | Film | Film | Film | Film |
| of antireflection | | thickness | thickness | thickness | thickness | thickness | thickness | thickness | thickness |
| layer | Substance | (nm) | ratio | (nm) | ratio | (nm) | ratio | (nm) | ratio |
| First film | Si₃N₄ | 181.25 | 5.8 | 39.34 | 1.1 | 32.10 | 1.9 | 34.68 | 1.6 |
| Second film | SiO₂ | 31.23 | 1.1 | 43.42 | 1.4 | 61.42 | 1.4 | 56.97 | 1.2 |
| Third film | Si₃N₄ | 29.30 | 1.7 | 59.32 | 1.7 | 43.44 | 1.2 | 49.18 | 1.1 |
| Fourth film | SiO₂ | 49.73 | 1.9 | 34.91 | 1.7 | 50.93 | 1.0 | 42.93 | 8.6 |
| Fifth film | Si₃N₄ | 95.77 | — | 58.76 | 1.1 | 50.40 | 1.6 | 5.02 | 1.2 |
| Sixth film | SiO₂ | — | — | 61.76 | 12.3 | 78.94 | 10.1 | 5.81 | 7.2 |
| Seventh film | Si₃N₄ | — | — | 5.01 | 8.8 | 7.78 | 3.3 | 41.83 | 2.8 |
| Eighth film | SiO₂ | — | — | 44.12 | — | 25.53 | — | 116.99 | — |
| Ninth film | Si₃N₄ | — | — | — | — | — | — | — | — |
| Tenth film | SiO₂ | — | — | — | — | — | — | — | — |

| Film | | Comparative Example 5 | | Comparative Example 6 | | Comparative Example 7 | |
|---|---|---|---|---|---|---|---|
| configuration | | Film | Film | Film | Film | Film | Film |
| of antireflection | | thickness | thickness | thickness | thickness | thickness | thickness |
| layer | Substance | (nm) | ratio | (nm) | ratio | (nm) | ratio |
| First film | Si₃N₄ | 9.02 | 6.7 | 17.52 | 2.8 | 8.23 | 3.6 |
| Second film | SiO₂ | 60.24 | 1.6 | 49.59 | 1.0 | 29.92 | 1.2 |
| Third film | Si₃N₄ | 38.73 | 1.4 | 48.70 | 1.1 | 36.14 | 1.3 |
| Fourth film | SiO₂ | 54.58 | 1.3 | 55.41 | 1.3 | 45.67 | 1.2 |
| Fifth film | Si₃N₄ | 43.45 | 1.5 | 41.76 | 1.2 | 55.02 | 1.8 |
| Sixth film | SiO₂ | 64.43 | 1.4 | 49.91 | 1.2 | 30.16 | 2.2 |
| Seventh film | Si₃N₄ | 46.51 | 1.2 | 59.17 | 1.6 | 66.86 | 1.6 |
| Eighth film | SiO₂ | 40.28 | 1.5 | 38.13 | 7.6 | 106.33 | — |
| Ninth film | Si₃N₄ | 59.16 | 1.9 | 5.05 | 13.8 | — | — |
| Tenth film | SiO₂ | 113.52 | — | 69.50 | — | — | — |

In the optical member of Comparative Example 1, the total number of films of the antireflection layer is five. A first film is a high refractive index film, and a fifth film which is the outermost film is a high refractive index film. A film thickness ratio is 1.1 or more and 5.8 or less.

In the optical member of Comparative Example 2, the total number of films of the antireflection layer is eight. A first film is a high refractive index film, and an eighth film which is the outermost film is a low refractive index film. A film thickness ratio is 1.1 or more and 12.3 or less. Specifically, a film thickness ratio between a sixth film and a seventh film is 12.3, and a film thickness ratio between the seventh film and the eighth film is 8.8.

In the optical member of Comparative Example 3, the total number of films of the antireflection layer is eight. Also here, a first film is a high refractive index film, and an eighth film which is the outermost film is a low refractive index film. A film thickness ratio is 1.0 or more and 10.1 or less. Specifically, a film thickness ratio between a sixth film and a seventh film is 10.1.

In the optical member of Comparative Example 4, the total number of films of the antireflection layer is eight. Also here, a first film is a high refractive index film, and an eighth film which is the outermost film is a low refractive index film. A film thickness ratio is 1.1 or more and 8.6 or less. Specifically, a film thickness ratio between a fourth film and a fifth film is 8.6, and a film thickness ratio between a sixth film and a seventh film is 7.2.

In the optical member of Comparative Example 5, the total number of films of the antireflection layer is ten. Also here, a first film is a high refractive index film, and a tenth film which is the outermost film is a low refractive index film. A film thickness ratio is 1.2 or more and 6.7 or less. Specifically, a film thickness ratio between a first film and a second film is 6.7.

In the optical member of Comparative Example 6, the total number of films of the antireflection layer is ten. Also here, a first film is a high refractive index film, and a tenth film which is the outermost film is a low refractive index film. A film thickness ratio is 1.0 or more and 13.8 or less. Specifically, a film thickness ratio between an eighth film and a ninth film is 7.6, and a film thickness ratio between the ninth film and the tenth film is 13.8.

In the optical member of Comparative Example 7, the total number of films of the antireflection layer is eight. Also here, a first film is a high refractive index film, and an eighth film which is the outermost film is a low refractive index film. A film thickness ratio is 1.2 or more and 3.6 or less.

Next, Table 5 shows a configuration of the antireflection layer in the optical members 100 of Examples 1 to 5 and the optical members of Comparative Examples 1 to 6.

TABLE 5

| | | | | | | Comparative | Comparative | Comparative |
|---|---|---|---|---|---|---|---|---|
| | Example 1 | Example 2 | Example 3 | Example 4 | Example 5 | Example 1 | Example 2 | Example 3 |
| Total number of films | 8 | 6 | 8 | 8 | 10 | 5 | 8 | 8 |
| of antireflection layer | | | | | | | | |
| Film thickness ratio | YES | YES | YES | YES | YES | YES | NO | NO |
| is six or less | | | | | | | | |
| Average reflectance (%) | 49.6 | 43.8 | 41.3 | 58.5 | 57.0 | 11.5 | 43.2 | 50.6 |
| 5° incidence 300-400 nm | | | | | | | | |
| Average reflectance (%) | 1.0 | 1.4 | 1.5 | 1.2 | 1.0 | 1.0 | 1.7 | 1.9 |
| 5° incidence 450-800 nm | | | | | | | | |
| Thermal shock resistance | ○ | ○ | ○ | ○ | ○ | x | x | x |
| (85° C. ⇔ −40° C. × | | | | | | | | |
| 1000 h) | | | | | | | | |
| Weather resistance | ○ | ○ | ○ | ○ | ○ | x | x | x |
| (weather meter | | | | | | | | |
| 180 W/m²) | | | | | | | | |

| | Comparative | Comparative | Comparative | Comparative |
|---|---|---|---|---|
| | Example 4 | Example 5 | Example 6 | Example 7 |
| Total number of films of | 8 | 10 | 10 | 8 |
| antireflection layer | | | | |
| Film thickness ratio is six | NO | NO | NO | YES |
| or less | | | | |
| Average reflectance (%) | 45.4 | 58.9 | 48.6 | 34.7 |
| 5° incidence 300-400 nm | | | | |
| Average reflectance (%) | 1.6 | 0.8 | 1.4 | 1.2 |
| 5° incidence 450-800 nm | | | | |
| Thermal shock resistance | x | x | x | ○ |
| (85° C. ⇔ −40° C. × | | | | |
| 1000 h) | | | | |
| Weather resistance | x | x | x | x |
| (weather meter | | | | |
| 180 W/m²) | | | | |

In the optical members 100 of Examples 1 to 5, peeling did not occur in the antireflection layer 130 even by a thermal shock test, but in the optical members of Comparative Examples 1 to 6, peeling occurred in the antireflection layer by a thermal shock test. Further, in the optical members 100 of Examples 1 to 5, peeling did not occur in the antireflection layer 130 also in a weather resistance test, but in the optical members of Comparative Examples 1 to 7, peeling occurred in the antireflection layer in a weather resistance test.

Note that the present technique can have a configuration below.

(1) An optical member including:
a light-transmissive member;
a hard coat layer covering the light-transmissive member; and
an antireflection layer covering the hard coat layer,
in which the antireflection layer is configured such that high refractive index films and low refractive index films are alternately stacked,
the high refractive index films contain Si₃N₄,
the low refractive index films contain SiO₂,
a total number of films of the high refractive index films and the low refractive index films is an even number,
a ratio of thickness of a thick film to thickness of a thin film of two adjacent films is six times or less for each of the high refractive index films and the low refractive index films in the antireflection layer, and
an average reflectance of the antireflection layer in a wavelength range of 300 to 400 nm is 40% or more.

(2) The optical member according to (1), in which the total number of films of the high refractive index films and the low refractive index films is ten or less.

(3) The optical member according to (1) or (2), in which the total number of films of the high refractive index films and the low refractive index films is six or more and eight or less.

(4) The optical member according to any of (1) to (3), in which a film located farthest from the hard coat layer in the antireflection layer is one of the low refractive index films.

(5) A lens unit including a plurality of lenses, in which at least one lens of a plurality of the lenses is the optical member according to any (1) to (3).

(6) The lens unit according to (5), further including a lens barrel to which a plurality of lenses can be attached, in which
the at least one lens is arranged to be exposed from the lens barrel, and
a remaining lens of a plurality of the lenses is arranged in the lens barrel.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. An optical member comprising:
a light-transmissive member;
a hard coat layer covering the light-transmissive member; and
an antireflection layer covering the hard coat layer,
wherein the antireflection layer is configured such that high refractive index films and low refractive index films are alternately stacked,
the high refractive index films contain Si₃N₄,
the low refractive index films contain SiO₂,
a total number of films of the high refractive index films and the low refractive index films is an even number,
a ratio of thickness of a thick film to thickness of a thin film of two adjacent films is six times or less for each of the high refractive index films and the low refractive index films in the antireflection layer, and
an average reflectance of the antireflection layer in a wavelength range of 300 to 400 nm is 40% or more.

2. The optical member according to claim 1, wherein the total number of films of the high refractive index films and the low refractive index films is ten or less.

3. The optical member according to claim 2, wherein the total number of films of the high refractive index films and the low refractive index films is six or more and eight or less.

4. The optical member according to claim 1, wherein a film located farthest from the hard coat layer in the antireflection layer is one of the low refractive index films.

5. A lens unit comprising a plurality of lenses, wherein at least one lens of the plurality of lenses is the optical member according to claim 1.

6. The lens unit according to claim 5, further comprising a lens barrel to which a plurality of lenses can be attached,
Wherein the at least one lens is arranged to be exposed from the lens barrel, and
a remaining lens of the plurality of lenses is arranged in the lens barrel.
